(19) United States
(12) Patent Application Publication
(10) Pub. No.: US 2021/0254546 A1
(43) Pub. Date: Aug. 19, 2021

(54) TWO-SHAFT GAS TURBINE

(71) Applicant: MITSUBISHI HEAVY INDUSTRIES, LTD., Tokyo (JP)

(72) Inventor: Yasunori KIMURA, Tokyo (JP)

(21) Appl. No.: 17/145,575

(22) Filed: Jan. 11, 2021

(30) Foreign Application Priority Data
Feb. 17, 2020 (JP) 2020-024293

(51) Int. Cl. F02C 3/10; F02C 3/04; F02C 3/13

(52) U.S. Cl. CPC F02C 3/10; F02C 3/04; F02C 3/13; F05D 2240/30; F05D 2240/60; F05D 2240/50; F05D 2220/32

(57) ABSTRACT

A two-shaft gas turbine includes a compressor, a high-pressure turbine including a first shaft connected to a rotation shaft of the compressor, a low-pressure turbine including a second shaft separate from the first shaft, and is provided coaxially to the high-pressure turbine with an interval in an axis direction between the low-pressure turbine and the high-pressure turbine, an intermediate flow path provided between a final stage rotor blade of the high-pressure turbine and a first stage rotor blade of the low-pressure turbine in the axis direction, the intermediate flow path being configured to supply a combustion gas from the high-pressure turbine to the low-pressure turbine, and a strut disposed inside the intermediate flow path. The strut concurrently functions as a first stage stator blade of the low-pressure turbine.

### CROSS-REFERENCE TO RELATED APPLICATIONS

This application claims the benefit of priority to Japanese Patent Application Number 2020-024293 filed on Feb. 17, 2020. The entire contents of the above-identified application are hereby incorporated by reference.

### TECHNICAL FIELD

The present disclosure relates to a two-shaft gas turbine.

### RELATED ART

In the related art, a known two-shaft gas turbine is provided with a high-pressure turbine and a low-pressure turbine on separate shafts and supplies a combustion gas that has passed through the high-pressure turbine to the low-pressure turbine through an intermediate duct.

For example, heavy duty two-shaft gas turbines have many advantages, such as being able to discretionarily adjust and select the rotation speed of the rotation shaft, being able to implement drive in a wide range of rotation speeds, being able to start a startup motor with little startup torque when starting the startup motor that rotates a compressor-driving turbine, and having good maintainability. Thus, heavy duty two-shaft gas turbine are used as turbines in various industrial machines, power generation devices, and the like and, in particular, a turbine for driving an industrial machine.

Compared to a single-shaft gas turbine, a two-shaft gas turbine has more weight and longer axial length, because two-shaft gas turbine includes greater number of shafts. Thus, there is a demand for a two-shaft gas turbine to be made as compact as possible.

In this regard, US 2019/0136702 A describes a two-shaft gas turbine for an aircraft engine that has reduced axial length, by designing a strut provided in an intermediate duct to concurrently function as a stator blade, that is, an integrated strut/stator blade design.

### SUMMARY

However, in cases such as the two-shaft gas turbine of US 2019/0136702 A in which the strut provided in the intermediate duct is designed to concurrently function as a stator blade, the axial length of the two-shaft gas turbine can be reduced. However, there is a problem in that a large energy loss occur due to high flow rates within the axial position range in which the strut is provided.

In light of the foregoing, an object of the present disclosure is to provide a two-shaft gas turbine that is compact and is capable of reducing energy loss of combustion gas.

An aspect of the present disclosure is a two-shaft gas turbine, including, a compressor, a high-pressure turbine including a first shaft connected to a rotation shaft of the compressor, a low-pressure turbine including a second shaft separate from the first shaft, and being provided coaxially to the high-pressure turbine with an interval in an axis direction between the low-pressure turbine and the high-pressure turbine, an intermediate flow path provided between a final stage rotor blade of the high-pressure turbine and a first stage rotor blade of the low-pressure turbine in the axis direction, the intermediate flow path being configured to supply a combustion gas from the high-pressure turbine to the low-pressure turbine, and a strut disposed inside the intermediate flow path, the strut concurrently functioning as a first stage stator blade of the low-pressure turbine, wherein B/A>C/B is satisfied, where an annular flow path area of the intermediate flow path at an outlet of the final stage rotor blade is defined as A, an annular flow path area of the intermediate flow path at a leading edge position of the strut is defined as B, and an annular flow path area of the intermediate flow path at a trailing edge position of the strut is defined as C.

According to the two-shaft gas turbine of an aspect of the present disclosure, because the strut provided in the intermediate flow path concurrently functions as the first stage stator blade of the low-pressure turbine, the size (axial length) can be reduced and the turbine can be made compact.

Furthermore, in the two-shaft gas turbine according to an aspect of the present disclosure, an area enlargement ratio B/A of the intermediate flow path at upstream of the strut is set to be greater than an area enlargement ratio C/B of the intermediate flow path within the range of the strut in the axis direction. Thus, the flow of the combustion gas can be slowed down, after passing through the outlet of the final stage rotor blade of the high-pressure turbine, and before entering the strut. Thus, loss within the strut can be reduced.

In this way, according to the two-shaft gas turbine of an aspect of the present disclosure, it is possible to realize a two-shaft gas turbine that is compact and is capable of reducing energy loss of the combustion gas.

### BRIEF DESCRIPTION OF DRAWINGS

The disclosure will be described with reference to the accompanying drawings, wherein like numbers reference like elements.

FIG. 1 is a diagram illustrating a two-shaft gas turbine of a first embodiment and a second embodiment.

FIG. 2 is a diagram illustrating an intermediate flow path section portion (intermediate flow path) of the two-shaft gas turbine of the first embodiment and the second embodiment and illustrating portion S of FIG. 1.

FIG. 3 is a diagram illustrating the differences in flow path area ratios of the intermediate flow path of a two-shaft gas turbine of a Comparative Example and the two-shaft gas turbine of the first embodiment and the second embodiment.

FIG. 4 is a diagram illustrating the positions of flow path areas A, B, and C of the intermediate flow path of the two-shaft gas turbine of the Comparative Example and the two-shaft gas turbine of the first embodiment and the second embodiment.

FIG. 5 is a diagram illustrating the flow of a combustion gas flowing into the intermediate flow path from a high-pressure turbine of the two-shaft gas turbine of the second embodiment.

FIG. 6 is a diagram illustrating a reference blade cross-section of a final stage stator blade of the high-pressure turbine of the two-shaft gas turbine of the second embodiment and a blade cross-section located radially inward from a mean position.

FIG. 7 is a front view illustrating the final stage stator blades of the high-pressure turbine of the two-shaft gas turbine of the second embodiment.

FIG. 8 is a diagram illustrating a modified example of the installed state of the final stage stator blade of the high-pressure turbine of the two-shaft gas turbine of the second embodiment.

FIG. 9 is a diagram illustrating an example of the throat state of the final stage stator blades of the high-pressure turbine of the two-shaft gas turbine of the second embodiment.

### DESCRIPTION OF EMBODIMENTS

### First Embodiment

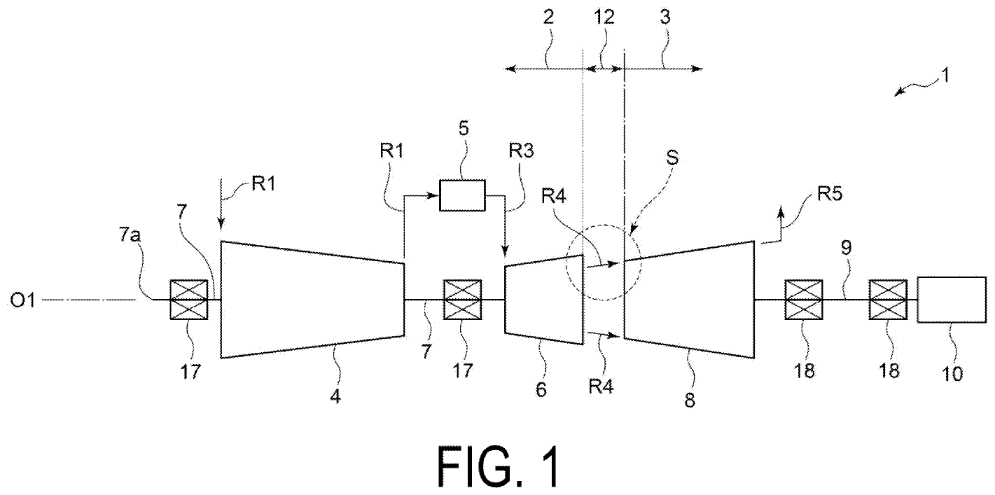

A two-shaft gas turbine according to the first embodiment will be described below with reference to FIGS. 1 to 4. Here, the two-shaft gas turbine of the present embodiment relates to a two-shaft gas turbine suitable for use as a heavy duty gas turbine for various industrial machines, power generation devices, and the like. Also, the two-shaft gas turbine of the present disclosure may be used as a gas turbine for other applications such as an aircraft (an aircraft engine).

As illustrated in FIG. 1, a two-shaft gas turbine 1 according to the present embodiment is provided with a compressor drive side turbine portion (gas generator portion) 2, and an output side turbine portion (power turbine portion) 3. The two-shaft gas turbine 1 is configured to drive a load device 10, such as an industrial machine and a generator motor, by the output side turbine portion 3. Also, the two-shaft gas turbine 1 is provided with a control device, a turbine casing containing the compressor drive side turbine portion 2 and the output side turbine portion 3, and the like, which are not illustrated.

The compressor drive side turbine portion 2 includes a compressor 4 that compresses air R1 taken in from the atmosphere and generates compressed air R2, a combustor 5 that combusts a mixture of the compressed air R2 supplied from the compressor 4 and fuel, and generates a combustion gas R3, and a high-pressure turbine 6 coaxially connected to the compressor 4 with a first shaft (gas generator shaft) 7, which concurrently functions as a rotor of the high-pressure turbine 6.

In the compressor drive side turbine portion 2, the high-pressure turbine 6 is rotated by the high-temperature and high-pressure combustion gas R3 supplied from the combustor 5, and the rotational power of the high-pressure turbine 6 is transmitted to the compressor 4 through the first shaft 7 to drive the compressor 4. Note that the first shaft 7 concurrently functions as the rotor of the high-pressure turbine 6.

The compressor 4 is provided with an inlet guide vane (IGV) in an air intake port. The IGV is driven by an IGV drive device, and the amount of air intake of the compressor can be adjusted by adjusting the degree of opening of the IGV.

A main component of the output side turbine portion 3 is a low-pressure turbine 8.

The low-pressure turbine 8 and the load device 10 are connected with a second shaft (power turbine shaft) 9 that concurrently functions as the rotor of the low-pressure turbine 8.

In the low-pressure turbine 8 of the present embodiment, the combustion gas R4, which drove the high-pressure turbine 6 and reduced in pressure, is supplied from the high-pressure turbine 6 to drive the rotation of the low-pressure turbine 8. The rotational power obtained by the low-pressure turbine 8 is transmitted to the load device 10 and drives the load device 10. A combustion gas R5 that has driven the low-pressure turbine 8 is released as exhaust gas.

As illustrated in FIGS. 1, 2, 3, and 4, the two-shaft gas turbine 1 according to the present embodiment is provided with an intermediate flow path section portion (intermediate flow path section) 12, which includes an intermediate duct 11 (an intermediate flow path 13) for supplying the combustion gas R4 from the high-pressure turbine 6 to the low-pressure turbine 8, between the compressor drive side turbine portion 2 and the output side turbine portion 3, i.e., between the high-pressure turbine 6 and the low-pressure turbine 8 in an axis O1 direction.

The intermediate duct 11 has a circular double tube structure provided with an inner tube 11a and an outer tube 11b disposed on the axis O1 and axis of the first shaft and the second shaft. The intermediate duct 11 is the intermediate flow path 13 which is the space between the inner tube 11a and the outer tube 11b through which the combustion gas R4 flows.

The intermediate flow path 13 (the intermediate duct 11) is provided between a final stage rotor blade 14 of the high-pressure turbine 6 and a first stage rotor blade 15 of the low-pressure turbine 8 in the axis O1 direction, and supplies the combustion gas R4 from the high-pressure turbine 6 to the low-pressure turbine 8.

Furthermore, in the two-shaft gas turbine 1 of the present embodiment, a strut 16, disposed in the intermediate flow path 13, is configured to concurrently function as a first stage stator blade of the low-pressure turbine 8. Note that a plurality of struts 16, which concurrently function as first stage stator blades of the low-pressure turbine 8, are disposed radially around the axis O1 inside the intermediate flow path 13.

Furthermore, because the strut 16 is an integrated strut/stator blade that concurrently functions as the first stage stator blade of the low-pressure turbine 8, the two-shaft gas turbine 1 of the present embodiment can achieve a decreased axial length (the length of the intermediate flow path section portion 12 and the like) and a compact size.

Note that the strut 16 being an integrated strut/stator blade that concurrently functions as a stator blade means that the strut 16 has a blade-like shape of a stator blade.

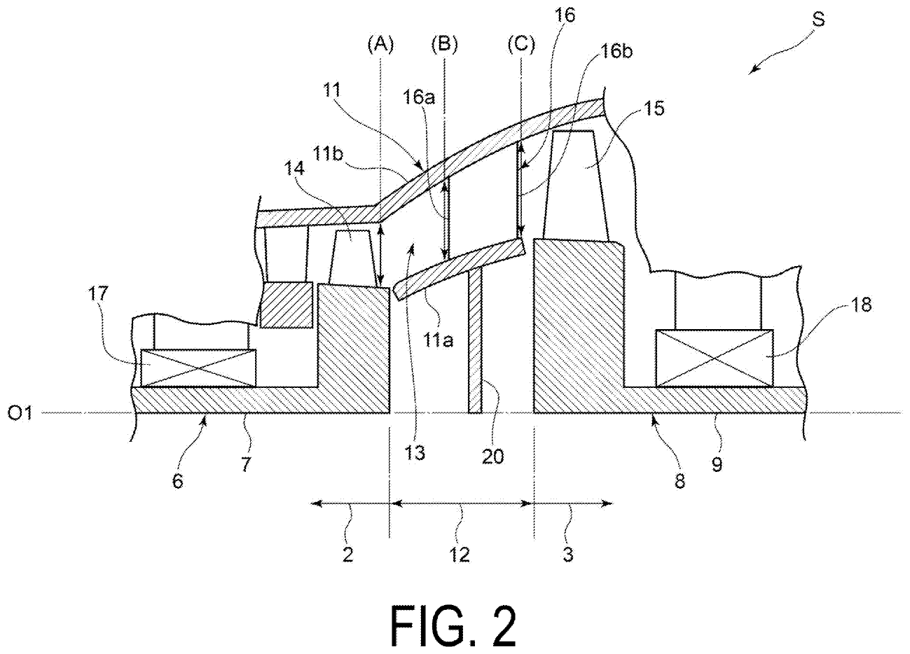

By decreasing the length of the intermediate flow path section portion 12 in this manner, the intermediate flow path 13 of the present embodiment is inclined with respect to the axis O1, and expanding radially outward as it extends from the high-pressure turbine 6 side toward the low-pressure turbine 8 side, as illustrated in FIGS. 2, 3, and 4. Furthermore, the intermediate flow path 13 of the present embodiment is provided with a smooth step portion 13a to facilitate the intermediate flow path 13 expanding radially outward. This step portion 13a enables the turbine to be made more compact.

In the present embodiment, the intermediate flow path 13 satisfies a condition that a maximum inclination angle θ1 with respect to the axis O1 of a hub endwall (the inner tube 11a of the intermediate duct 11), which forms the radially inner boundary of the intermediate flow path 13, is 30° or greater. Furthermore, the intermediate flow path 13 satisfies a condition that a maximum inclination angle θ2 with respect to the axis O1 of a tip endwall (the outer tube 11b of the intermediate duct 11), which forms the radially outer boundary of the intermediate flow path 13, is 40° or greater.

In the two-shaft gas turbine 1 of the present embodiment, as illustrated in FIGS. 1 and 2, the first shaft 7 is supported by a bearing (stationary member) 17 at both a first end portion 7a side that extends farther to the front side in the axis O1 direction than the compressor 4 and an intermediate portion between the compressor 4 and the high-pressure turbine 6. The second shaft 9 is supported by a bearing 18 at an intermediate portion between the low-pressure turbine 8 and the load device 10.

In this way, no bearings 17 or 18 are provided in the intermediate flow path section portion 12. Thus, compared to an example in which the bearing 17 or 18 is provided in the intermediate flow path section portion 12, the length of the intermediate flow path section portion 12 can be further decreased. This allows the two-shaft gas turbine 1 of the present embodiment can be made even more compact with the intermediate flow path 13 expanding greatly outwards in the radial direction.

As illustrated in FIG. 2, the intermediate flow path section portion 12 is provided with a pressure bulkhead 20 of a stationary member that divides the high-pressure turbine 6 and the low-pressure turbine 8 between the high-pressure turbine 6 and the low-pressure turbine 8 in the axis O1 direction, and at radially inward from the intermediate flow path 13 (the inner tube 11a of the intermediate duct 11). The pressure bulkhead 20 is held by the strut 16, extends radially inward from the inner tube 11a of the intermediate duct 11, and is provided dividing the high-pressure turbine 6 and the low-pressure turbine 8.

Here, as described above, in the case in which the strut 16 concurrently functions as a stator blade, the intermediate flow path section portion 12 is shortened, and the intermediate flow path 13 expands greatly radially outward, there is a risk that a large loss will occur when passing the strut 16.

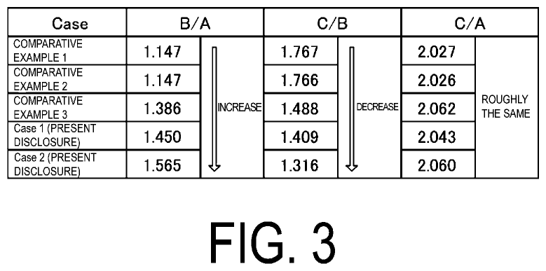

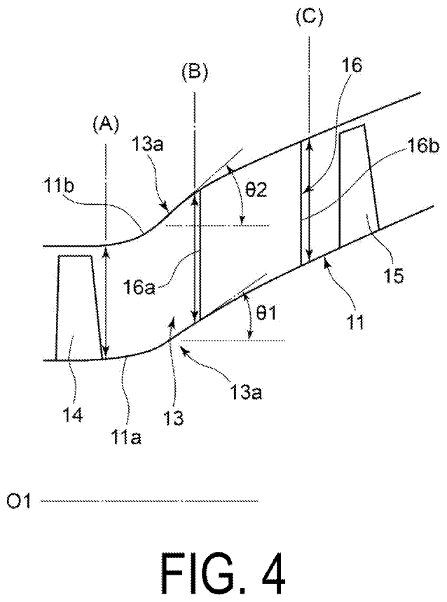

Taking this into consideration, in the two-shaft gas turbine 1 according to the present embodiment, as illustrated in FIGS. 3 and 4 (FIG. 2), the intermediate flow path 13 is configured to satisfy B/A>C/B, where the annular flow path area of the intermediate flow path 13 at the outlet of the final stage rotor blade 14 of the high-pressure turbine 6 is defined as A, the annular flow path area of the intermediate flow path 13 at a leading edge 16a position of the strut 16 is defined as B, and the annular flow path area of the intermediate flow path 13 at a trailing edge 16b position of the strut 16 is defined as C.

Here, the flow path areas A, B, and C described above represent the flow path area of the vertical cross section in a direction orthogonal to the axis O1.

In addition, in the case in which the position of the trailing edge of the final stage rotor blade 14 in the axis O1 direction is different depending on the blade height position (in other words, the trailing edge of the final stage rotor blade 14 is not parallel with the radial direction), the “outlet of the final stage rotor blade”, which is a reference used to define the annular flow path area A, is a point furthest downstream in the axis O1 direction of the trailing edge of the final stage rotor blade 14, and the annular flow path area A is defined. Since the annular flow path area A is the area of the “annular” flow path, the annular flow path area A is flow path area at a position in the axis O1 direction of the intermediate flow path 13 where the final stage rotor blade 14 is not present.

Similarly, in the case in which the position of the leading edge 16a of the strut 16, which is concurrently functioning as a stator blade, in the axis O1 direction is different depending on the blade height position (in other words, the leading edge 16a of the strut 16 is not parallel with the radial direction), the “leading edge position of the strut”, which is a reference used to define the annular flow path area B, is a point furthest upstream in the axis O1 direction of the leading edge 16a of the strut 16, and the annular flow path area B is defined. Since the annular flow path area B is the area of the “annular” flow path, the annular flow path area B is flow path area at a position in the axis O1 direction of the intermediate flow path 13 where the strut 16 is not present just upstream from the leading edge 16a of the strut 16.

Also, in the case in which the position of the trailing edge 16b of the strut 16, which is concurrently functioning as a stator blade, in the axis O1 direction is different depending on the blade height position (in other words, the trailing edge 16b of the strut 16 is not parallel with the radial direction), the “trailing edge position of the strut”, which is a reference used to define the annular flow path area C, is a point furthest downstream in the axis O1 direction of the trailing edge 16b of the strut 16, and the annular flow path area C is defined. Since the annular flow path area C is the area of the “annular” flow path, the annular flow path area C is flow path area at a position in the axis O1 direction of the intermediate flow path 13 where the strut 16 is not present.

In the intermediate flow path 13 of the two-shaft gas turbine 1 of the present embodiment, an area ratio C/A between the annular flow path area A of the intermediate flow path 13 and the annular flow path area C of the intermediate flow path 13 is 1.8 or greater (C/A≥1.8).

For example, as illustrated in FIGS. 3 and 4, compared to the structure of the intermediate flow path of Comparative Examples 1 to 3, in the intermediate flow path 13 of the two-shaft gas turbine 1 of the present embodiment, the area ratio B/A is large, the area ratio C/B is small, and the area ratio C/A is similar to that in the related art.

In other words, in the example of the Case 1 and the Case 2 in FIG. 3, the annular area until the strut 16 that concurrently functions as a stator blade is enlarged, and the enlargement ratio of the annular area in the strut 16 is reduced. In addition, under the constraint that C/A is kept approximately constant, a greater amount of area enlargement on the upstream side of the strut 16 is ensured.

Furthermore, in the two-shaft gas turbine 1 of the present embodiment, first, since the strut 16, provided in the intermediate flow path 13, concurrently functions as the first stage stator blade of the low-pressure turbine 8, the axial length can be reduced and the turbine can be made compact.

Furthermore, the area enlargement ratio B/A of the intermediate flow path 13 at upstream of the strut 16 is set to be greater than the area enlargement ratio C/B of the intermediate flow path 13 within the range of the strut 16 in the axis O1 direction. Thus, the flow of the combustion gas R4 can be slowed down, after passing through the outlet of the final stage rotor blade 14 of the high-pressure turbine 6, and before entering the strut 16.

In other words, the annular area enlargement ratio of the intermediate flow path 13 at upstream of the strut 16 is set to be greater than that in the related art, and the annular area enlargement ratio of the intermediate flow path 13, which needs to be enlarged in the axial position range where the strut 16 is provided, is set to be less than in the related art. Thus, the flow of the combustion gas R4, before entering the strut 16, can be sufficiently slowed down, and an energy loss when the combustion gas R4 flows through struts 16 adjacent in the circumferential direction can be minimized or prevented.

Thus, according to the two-shaft gas turbine 1 of the present embodiment, it is possible to realize the two-shaft gas turbine 1 that is compact and is capable of reducing energy loss of the combustion gas.

Additionally, in the two-shaft gas turbine 1 of the present embodiment, by satisfying C/A≥1.8, a large C/A can be ensured and the axial length of the intermediate flow path 13, in other words, the axial length of the intermediate flow path section portion 12, can be decreased. In this way, loss in the strut 16 can be reduced and the size can be kept small. Thus, the two-shaft gas turbine 1 which is even more highly efficient and compact can be achieved.

In the two-shaft gas turbine 1 of the present embodiment, the intermediate flow path 13 is inclined with respect to the axis O1, and expanding radially outward as it extends from the high-pressure turbine 6 side toward the low-pressure turbine 8 side.

In this way, high efficiency can be achieved and the axial length can be reduced. Thus, compared to that in the related art which tends to have a large size, the two-shaft gas turbine 1 can be made compact.

Also, in the two-shaft gas turbine 1 of the present embodiment, the maximum inclination angle θ1 with respect to the axis O1 of the hub endwall (the inner tube 11a), which forms the radially inner boundary of the intermediate flow path 13, is 30° or greater. This allows high efficiency to be achieved and the axial length to be reduced as appropriate. Thus, the two-shaft gas turbine 1 can be made compact.

Furthermore, in the two-shaft gas turbine 1 of the present embodiment, the maximum inclination angle θ2 with respect to the axis O1 of the tip endwall (outer tube 11b), which forms the radially outer boundary of the intermediate flow path 13, is 40° or greater. This allows high efficiency to be achieved and the axial length to be reduced as appropriate. Thus, the two-shaft gas turbine 1 can be made compact.

Also, in the two-shaft gas turbine 1 according to the present embodiment, the pressure bulkhead 20 that divides the high-pressure turbine 6 and the low-pressure turbine 8 is provided between the high-pressure turbine 6 and the low-pressure turbine 8 in the axis O1 direction, and at radially inward from the intermediate flow path 13, and the pressure bulkhead 20 is supported (held) by the strut 16 that concurrently functions as a stator blade. Thus, high efficiency can be further achieved and the axial length can be further reduced, allowing the two-shaft gas turbine 1 to be made more compact.

In addition, the first shaft 7 is supported by the bearing 17 at a first end portion 7a side that extends farther to the front side in the axis O1 direction than the compressor 4 and an intermediate portion between the compressor 4 and the high-pressure turbine 6. Thus, the first shaft 7 can be supported without providing the bearing 17 in the intermediate flow path section portion 12 between the high-pressure turbine 6 and the low-pressure turbine 8. In this way, the axial length of the intermediate flow path section portion 12 can be reduced. Thus, high efficiency can be further achieved and the two-shaft gas turbine 1 can be made compact.

The two-shaft gas turbine according to the first embodiment has been described, but the two-shaft gas turbine of the present disclosure is not limited to the first embodiment described above, and modifications can be made as appropriate within a scope that does not deviate from the spirit of the present disclosure.

For example, in the configuration described above, the bearing 17 that supports the first shaft 7 is not provided in the intermediate flow path section portion 12. However, a configuration may be used in which the bearing 17 that supports the first shaft 7 is provided in the intermediate flow path section portion 12 and the bearing 17 of this stationary member is supported by the strut 16.

### Second Embodiment

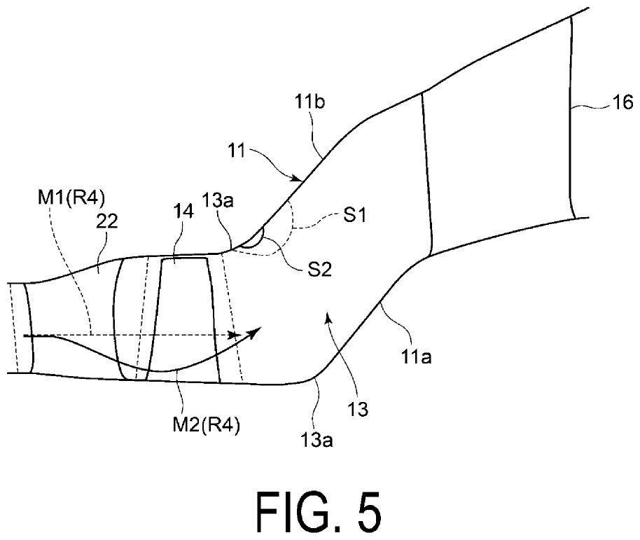

Next, A two-shaft gas turbine according to the second embodiment will be described below with reference to FIGS. 5 to 9 (and FIGS. 1, 2, 3, and 4). Here, with respect to the configuration of the two-shaft gas turbine of the first embodiment, the shape and arrangement of the stator blade in the final stage of the high-pressure turbine of the two-shaft gas turbine of the present embodiment are different, and other configurations are the same. Thus, in the present embodiment, the same components as those of the first embodiment are denoted by the same reference signs, and a detailed description thereof will be omitted.

In the first embodiment described above, the area enlargement ratio B/A of the intermediate flow path 13 at upstream of the strut 16 is set to be greater than the area enlargement ratio C/B of the intermediate flow path 13 within the range of the strut 16 in the axis O1 direction. Thus, the flow of the combustion gas R4 can be slowed down, after passing through the outlet of the final stage rotor blade 14 of the high-pressure turbine 6, and before entering the strut 16. Furthermore, the annular area enlargement ratio of the intermediate flow path 13, which needs to be enlarged in the axial position range where the strut 16 is provided, is less than in the related art. Thus, the flow of the combustion gas R4 before entering the strut 16 can be sufficiently slowed down, and an energy loss when the combustion gas R4 flows through struts 16 adjacent in the circumferential direction can be minimized or prevented.

However, as illustrated in FIG. 5, in a configuration such as the two-shaft gas turbine 1 of the first embodiment in which the flow path area of the intermediate flow path 13 is enlarged at a portion before the combustion gas R4 flows into the strut 16, when the flow of the combustion gas R4 along the axial direction (dashed arrow M1 in FIG. 5) flows into the intermediate flow path 13, separation S1 may occur in the vicinity of the tip endwall (the outer tube 11b of the intermediate duct 11). In particular, in the case of the step portion 13a being located in the intermediate flow path 13, the separation S1 is more likely to occur in the vicinity of the step portion 13a of the tip endwall.

With regards to this, with respect to the two-shaft gas turbine 1 of the first embodiment described with reference to FIGS. 1, 2, 3, and 4, the two-shaft gas turbine 1 of the present embodiment further includes the following configuration relating to stator blade 22 of the final stage of the high-pressure turbine 6.

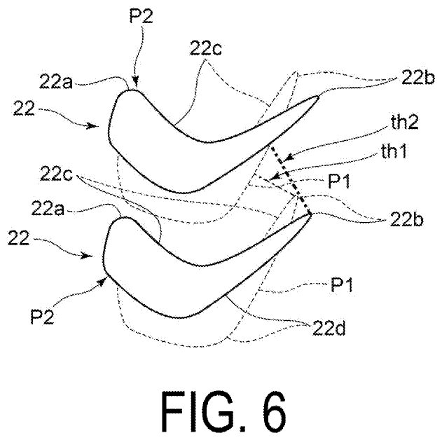

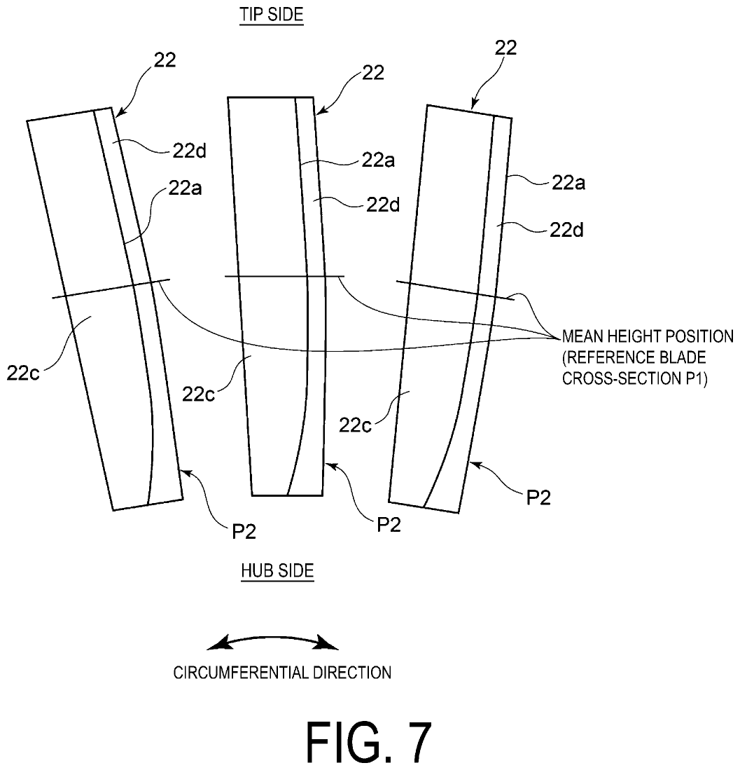

As illustrated in FIGS. 6 and 7, the stator blade 22 of the final stage of the high-pressure turbine 6 includes at least a portion of a blade cross-section P2, which is located radially inward of a reference blade cross-section P1 at a mean height (average diameter), is formed in a manner in which a leading edge 22a position is shifted further toward a pressure side 22c than that of the reference blade cross-section P1.

With respect to the blade cross-section P2 positioned radially inward from the mean height, when the position of the leading edge 22a is shifted further toward the pressure side 22c in the circumferential direction than that of the reference blade cross-section P1 of the mean height, the flow of the combustion gas R4 that passes through the stator blade 22 of the final stage changes direction to a radially inward direction. Then, the combustion gas R4 that flows out from the stator blade 22 of the final stage is turned radially inward toward the final stage rotor blade 14 of the high-pressure turbine 6, and is turned radially outward when it passes through the final stage rotor blade 14 of the high-pressure turbine 6 (see solid arrow M2 in FIG. 5).

In this way, the flow M2 of the combustion gas flowing out from the final stage rotor blade 14 is turned radially outward, compared to a flow M1 of the combustion gas that follows the axial direction. This allows separation in the vicinity of the tip endwall of the intermediate flow path 13 to be reduced (see separation S2 in FIG. 5).

Furthermore, in the stator blade 22 of the final stage of the high-pressure turbine 6 of the present embodiment, the blade cross-section P2 in the portion located radially inward from the reference blade cross-section P1 may be formed in a manner in which the position of a trailing edge 22b is shifted further toward a suction side than that of the reference blade cross-section P1.

In this way, a throat length, which is between the final stage stator blades 22 adjacent in the circumferential direction, can be formed to have a distribution of the throat length in the radial direction, in which a throat length th2 on the hub side (radially inward from the mean height) is longer, compared to a reference throat length th1 at the mean height. As a result, more combustion gas is biased to flow toward the hub side between the final stage stator blades 22, and the flow of the combustion gas R4 that passes through the stator blades 22 of the final stage can be effectively turned radially inward, allowing the flow M2 of the combustion gas that can contribute to the reduction of separation to be reliably formed.

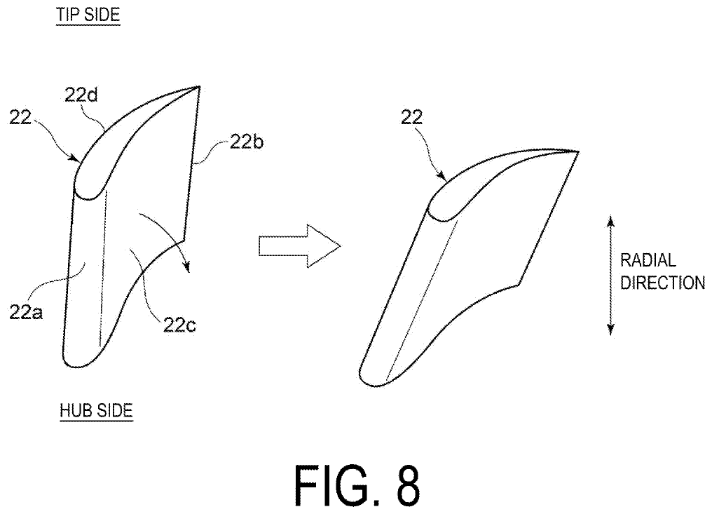

In another embodiment, as illustrated in FIG. 8, the stator blade 22 of the final stage of the high-pressure turbine 6 are disposed inclined with respect to the radial direction. Specifically, as the stator blade 22 extends toward the hub side (radially inward), the stator blade 22 is inclined with respect to the radial direction so as to shift the position of the blade cross-section further toward the suction side.

In the case in which the stator blade 22 is inclined with respect to the radial direction in this manner, the flow of the combustion gas between the final stage stator blades 22 is biased toward the hub side, and the flow of the combustion gas R4 passing through the stator blades 22 of the final stage is turned radially inward. This allows the flow M2 of the combustion gas that can contribute to the reduction of separation to be formed.

Note that the distribution of the throat length achieved by the configuration illustrated in FIG. 7 of the stator blade 22 of the final stage of the high-pressure turbine 6 is not particularly limited as long as the flow of the combustion gas between the final stage stator blades is biased toward the hub side.

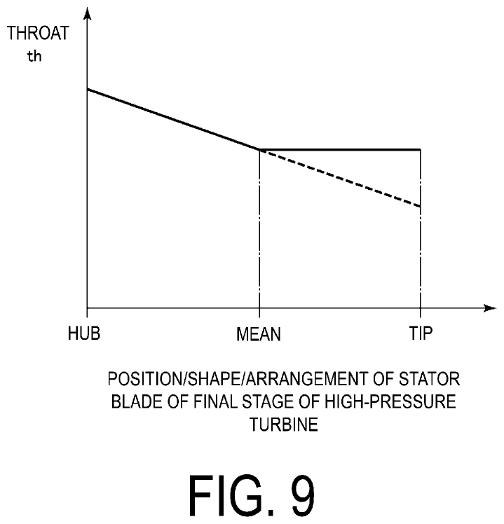

For example, as illustrated in FIG. 9, the throat length between the final stage stator blades 22 adjacent in the circumferential direction of the high-pressure turbine 6 may be configured to be greater than the reference throat length th1 at the mean height at a position radially inward from the mean height of the final stage stator blades 22, in other words, a position on the hub side. Note that the final stage stator blades 22 may be configured so that the throat length th at a position on the tip side, in other words, radially outward from the mean height, is less than the reference throat length th1 at the mean height.

As described above, according to the two-shaft gas turbine 1 of the present embodiment, even in the case in which the intermediate flow path 13 is formed expanding radially outward as it extends from the high-pressure turbine 6 to the low-pressure turbine 8, the occurrence of a separation phenomenon, in which the flow of the combustion gas R4 separates from the wall surface, can be reduced. This allows the effects of the first embodiment to be achieved and loss due to the separation phenomenon to be reduced.

In addition, in the two-shaft gas turbine 1 of the present embodiment, the blade cross-section P2 located on the radially inward from the reference blade cross-section P1 includes the trailing edge 22b that is shifted further toward the suction side 22d than that of the reference blade cross-section P1. Thus, the throat length th2 at the hub side can be set to a greater value than the reference throat length th1. Accordingly, the flow axis of the combustion gas R4 flowing from the high-pressure turbine 6 to the inlet of the intermediate flow path 13 can be shifted radially inward. In this way, it is possible to further favorably reduce the separation phenomenon in the flow of the combustion gas R4.

The two-shaft gas turbine according to the second embodiment has been described, but the two-shaft gas turbine of the present disclosure is not limited to the second embodiment described above, and, including the configuration and modified examples of the first embodiment, modifications can be made as appropriate within a scope that does not deviate from the spirit of the present disclosure.

The contents of the embodiments described above can be understood as follows, for example.

(1) A two-shaft gas turbine (1) according to an aspect includes, a compressor (4), a high-pressure turbine (6) including a first shaft (7) connected to a rotation shaft of the compressor, a low-pressure turbine (8) including a second shaft (9) separate from the first shaft, and being provided coaxially to the high-pressure turbine with an interval in an axis (O1) direction between the low-pressure turbine (8) and the high-pressure turbine, an intermediate flow path (13) provided between a final stage rotor blade (14) of the high-pressure turbine and a first stage rotor blade (15) of the low-pressure turbine in the axis direction, the intermediate flow path (13) is configured to supplying a combustion gas (R4) from the high-pressure turbine to the low-pressure turbine; and a strut (16) disposed inside the intermediate flow path, the strut (16) concurrently functions as a first stage stator blade of the low-pressure turbine, wherein B/A>C/B is satisfied, where an annular flow path area of the intermediate flow path at an outlet of the final stage rotor blade is defined as A, an annular flow path area of the intermediate flow path at a leading edge (16a) position of the strut is defined as B, and an annular flow path area of the intermediate flow path at a trailing edge (16b) position of the strut is defined as C.

According to a two-shaft gas turbine of the present disclosure, since the strut provided in the intermediate flow path concurrently functions as the first stage stator blade of the low-pressure turbine, the axial length can be reduced and, compared to that in the related art which tends to have a large size, the two-shaft gas turbine can be made compact.

Furthermore, the area enlargement ratio B/A of the intermediate flow path at upstream of the strut is set to be greater than the area enlargement ratio C/B of the intermediate flow path within the range of the strut in the axis direction. Thus, the flow of the combustion gas can be slowed down, after passing through the outlet of the final stage rotor blade of the high-pressure turbine, and before entering the strut. Thus, loss within the axial position range where the strut is provided can be reduced.

In this way, it is possible to realize a two-shaft gas turbine that is compact and is capable of reducing energy loss of the combustion gas.

(2) A two-shaft gas turbine according to another aspect is the two-shaft gas turbine of (1), wherein the intermediate flow path is inclined with respect to the axis, expanding radially outward as the intermediate flow path extends from the high-pressure turbine side toward the low-pressure turbine side.

According to a two-shaft gas turbine of the present disclosure, high efficiency can be achieved and the axial length can be reduced. Thus, the two-shaft gas turbine can be made compact.

(3) A two-shaft gas turbine according to another aspect is the two-shaft gas turbine of (1) or (2), wherein the intermediate flow path includes a hub endwall (11a) that forms a radially inner boundary of the intermediate flow path, the hub endwall (11a) having a maximum inclination angle with respect to the axis of 30° or greater.

According to a two-shaft gas turbine of the present disclosure, high efficiency can be achieved and the axial length can be suitably reduced. Thus, the two-shaft gas turbine can be made compact.

(4) A two-shaft gas turbine according to another aspect is the two-shaft gas turbine of any one of (1) to (3), wherein the intermediate flow path includes a tip endwall (11b) that forms a radially outer boundary of the intermediate flow path, the tip endwall (11b) having a maximum inclination angle with respect of the axis of 40° or greater.

According to a two-shaft gas turbine of the present disclosure, high efficiency can be achieved and the axial length can be suitably reduced. Thus, the two-shaft gas turbine can be made compact.

(5) A two-shaft gas turbine according to another aspect is the two-shaft gas turbine of (1) or (2), wherein a pressure bulkhead (20) that divides the high-pressure turbine and the low-pressure turbine is provided between the high-pressure turbine and the low-pressure turbine in the axis direction, and at radially inward of the intermediate flow path, the pressure bulkhead (20) is supported by the strut.

According to a two-shaft gas turbine of the present disclosure, for example, in cases in which the bearing on the high-pressure turbine side and the low-pressure turbine side are not provided in the intermediate flow path section between the high-pressure turbine and the low-pressure turbine, a pressure bulkhead that divides the high-pressure turbine side and the low-pressure turbine side by interposing in the intermediate flow path can be supported by an integrated strut/stator blade strut provided in the intermediate flow path. In other words, with the configuration described above, a bearing does not need to be provided in the intermediate flow path section. In this way, high efficiency can be further achieved and the axial length can be reduced. Thus, the two-shaft gas turbine can be made compact.

(6) A two-shaft gas turbine according to another aspect is the two-shaft gas turbine of any one of (1) to (5), wherein the first shaft is supported by a bearing (17) at both a first end portion (7a) side that extends farther to a front side in the axis direction than the compressor and an intermediate portion between the compressor and the high-pressure turbine.

According to a two-shaft gas turbine of the present disclosure, the first shaft is supported by the bearing at the first end portion side that extends farther to the front side in the axis direction than the compressor and an intermediate portion between the compressor and the high-pressure turbine. Thus, the first shaft can be supported without providing the bearing in the intermediate flow path section between the high-pressure turbine and the low-pressure turbine. In this way, the axial length of the intermediate flow path section can be reduced. Thus, high efficiency can be further achieved and the two-shaft gas turbine can be made compact.

(7) A two-shaft gas turbine according to another aspect is the two-shaft gas turbine of any one of (1) to (6), wherein an area ratio C/A between the annular flow path area A of the intermediate flow path and the annular flow path area C of the intermediate flow path is 1.8 or greater, that is C/A≥1.8.

According to a two-shaft gas turbine of the present disclosure, by satisfying C/A≥1.8, a large C/A can be ensured and the intermediate flow path (the axial length of the intermediate flow path section) can be decreased. In this way, loss in the strut can be reduced and the axial length can be kept small. Thus, the two-shaft gas turbine which is even more highly efficient and compact can be achieved.

(8) A two-shaft gas turbine according to another aspect is the two-shaft gas turbine of any one of (1) to (7), wherein a final stage stator blade (22) of the high-pressure turbine is located radially inward from a reference blade cross-section (P1) at a mean height, and includes a blade cross-section with a leading edge (22a) position shifted further toward a pressure side (22c) than the leading edge position of the reference blade cross-section.

According to a two-shaft gas turbine of the present disclosure, the stator blade of the final stage of the high-pressure turbine includes a blade cross-section that is located radially inward of the reference blade cross-section at the mean height, and the leading edge position is shifted further toward the pressure side than that of the reference blade cross-section, and thus, by turning the combustion gas flowing toward the final stage rotor blade of the high-pressure turbine radially inward, the combustion gas flowing into the intermediate flow path from the final stage rotor blade can be turned radially outward. In this way, even in the case in which the intermediate flow path is formed expanding radially outward as it extends from the high-pressure turbine to the low-pressure turbine, the occurrence of the separation phenomenon, in which the flow of the combustion gas separates from the wall surface, can be reduced. This allows the occurrence of energy loss from the combustion gas due to the separation phenomenon to be reduced.

(9) A two-shaft gas turbine according to another aspect is the two-shaft gas turbine of (8), wherein a trailing edge (22b) position of the blade cross-section is shifted further toward a suction side (22d) than the trailing edge position of the reference blade cross-section.

According to a two-shaft gas turbine of the present disclosure, the trailing edge position of the blade cross-section is shifted further toward the suction side than that of the reference blade cross-section. Thus, it is possible to more effectively set the throat length between the stator blades on the hub side (radially inward) to be greater than the reference throat length at the mean height. In this way, the flow of the combustion gas toward the final stage rotor blade can be directed radially inward and the flow of the combustion gas flowing from the final stage rotor blade into the intermediate flow path can be turned radially outward. Thus, it is possible to further favorably reduce the separation phenomenon in the flow of the combustion gas and to reduce the occurrence of energy loss of the combustion gas due to the separation phenomenon.

(10) A two-shaft gas turbine according to another aspect is the two-shaft gas turbine of any one of (1) to (9), wherein a throat length (th2) between final stage stator blades adjacent in a circumferential direction of the high-pressure turbine is greater than a reference throat length (th1) at a mean height, at a position radially inward from the mean height of the final stage stator blades.

Accordingly to a two-shaft gas turbine of the present disclosure, the throat length between the final stage stator blades adjacent in the circumferential direction of the high-pressure turbine is greater than the reference throat length at the mean height at a position radially inward from the mean height of the final stage stator blades. In this way, the flow of the combustion gas toward the final stage rotor blade can be directed radially inward and the flow of the combustion gas flowing from the final stage rotor blade into the intermediate flow path can be turned radially outward. Thus, even in the case in which the intermediate flow path is formed expanding radially outward as it extends from the high-pressure turbine to the low-pressure turbine, the occurrence of the separation phenomenon in the combustion gas flow can be reduced. This allows the occurrence of energy loss of the combustion gas due to the separation phenomenon to be reduced.

(11) A two-shaft gas turbine according to another aspect is the two-shaft gas turbine of any one of (1) to (10), wherein a final stage stator blade of the high-pressure turbine is formed to shift a flow axis of the combustion gas radially inward, the combustion gas is flowing toward the final stage rotor blade of the high-pressure turbine.

According to a two-shaft gas turbine having the configuration described above, when combustion gas directed radially inward by the final stage stator blade flows into the final stage rotor blade, the combustion gas is turned radially outward when passing through the final stage rotor blade. Thus, the combustion gas flowing into the intermediate flow path from the final stage rotor blade will have a radially outward speed component, and separation of the radially outer wall surface (tip wall) of the intermediate flow path can be reduced.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A two-shaft gas turbine, comprising:
a compressor;
a high-pressure turbine including a first shaft connected to a rotation shaft of the compressor;
a low-pressure turbine including a second shaft separate from the first shaft, and being provided coaxially to the high-pressure turbine with an interval in an axis direction between the low-pressure turbine and the high-pressure turbine;
an intermediate flow path provided between a final stage rotor blade of the high-pressure turbine and a first stage rotor blade of the low-pressure turbine in the axis direction, the intermediate flow path being configured to supply a combustion gas from the high-pressure turbine to the low-pressure turbine; and
a strut disposed inside the intermediate flow path, the strut concurrently functioning as a first stage stator blade of the low-pressure turbine, wherein
B/A>C/B is satisfied,
where an annular flow path area of the intermediate flow path at an outlet of the final stage rotor blade is defined as A,
an annular flow path area of the intermediate flow path at a leading edge position of the strut is defined as B, and
an annular flow path area of the intermediate flow path at a trailing edge position of the strut is defined as C.

2. The two-shaft gas turbine according to claim 1, wherein
the intermediate flow path is inclined with respect to the axis, expanding radially outward as the intermediate flow path extends from the high-pressure turbine side toward the low-pressure turbine side.

3. The two-shaft gas turbine according to claim 1, wherein
the intermediate flow path includes a hub endwall that forms a radially inner boundary of the intermediate flow path, the hub endwall having a maximum inclination angle with respect to the axis of 30° or greater.

4. The two-shaft gas turbine according to claim 1, wherein
the intermediate flow path includes a tip endwall that forms a radially outer boundary of the intermediate flow path, the tip endwall having a maximum inclination angle with respect to the axis of 40° or greater.

5. The two-shaft gas turbine according to claim 1, wherein
a pressure bulkhead that divides the high-pressure turbine and the low-pressure turbine is provided between the high-pressure turbine and the low-pressure turbine in the axis direction, and at radially inward of the intermediate flow path, the pressure bulkhead is supported by the strut.

6. The two-shaft gas turbine according to claim 1, wherein
the first shaft is supported by a bearing at both a first end portion side that extends farther to a front side in the axis direction than the compressor and an intermediate portion between the compressor and the high-pressure turbine.

7. The two-shaft gas turbine according to claim 1, wherein
an area ratio C/A between the annular flow path area A of the intermediate flow path and the annular flow path area C of the intermediate flow path is 1.8 or greater, that is C/A≥1.8.

8. The two-shaft gas turbine according to claim 1, wherein
a final stage stator blade of the high-pressure turbine is located radially inward from a reference blade cross-section at a mean height, and includes a blade cross-section with a leading edge position shifted further toward a pressure side than the leading edge position of the reference blade cross-section.

9. The two-shaft gas turbine according to claim 8, wherein
a trailing edge position of the blade cross-section is shifted further toward a suction side than the trailing edge position of the reference blade cross-section.

10. The two-shaft gas turbine according to claim 1, wherein
a throat length between final stage stator blades adjacent in a circumferential direction of the high-pressure turbine is greater than a reference throat length at a mean height, at a position radially inward from the mean height of the final stage stator blades.

11. The two-shaft gas turbine according to claim 1, wherein
a final stage stator blade of the high-pressure turbine is formed to shift a flow axis of the combustion gas radially inward, the combustion gas is flowing toward the final stage rotor blade of the high-pressure turbine.
